(19) United States
(12) Patent Application Publication
(10) Pub. No.: US 2026/0139092 A1
(43) Pub. Date: May 21, 2026

(54) POLYESTER FILM

(71) Applicant: TOYOBO CO., LTD., Osaka-shi, Osaka (JP)

(72) Inventors: Shinya WATANABE, Tsuruga (JP); Makoto HANDA, Tsuruga (JP)

(73) Assignee: TOYOBO CO., LTD., Osaka-shi, Osaka (JP)

(21) Appl. No.: 19/120,144

(22) PCT Filed: Oct. 10, 2023
(86) PCT No.: PCT/JP2023/036716

§ 371 Date: Apr. 10, 2025

(30) Foreign Application Priority Data
Oct. 13, 2022 (JP) 2022-164791

(51) Int. Cl. C08G 63/189; C08J 5/18

(52) U.S. Cl. CPC C08G 63/189; C08J 5/18; C08J 2367/02

(57) ABSTRACT

Provided is a polyester film that contains a component derived from a biomass raw material, which is environmentally friendly, and also achieves various properties at high levels. Disclosed as the polyester film is a polyester film comprising a polyester that comprises a diol unit containing an ethylene glycol unit derived from a biomass raw material and a dicarboxylic acid unit containing a naphthalenedicarboxylic acid unit.

### TECHNICAL FIELD

The present disclosure relates to a polyester film.

### BACKGROUND ART

Polyester films, especially those such as polyethylene terephthalate films and polyethylene naphthalate films, are widely used as various materials because of their excellent mechanical properties, heat resistance, and chemical resistance.

In recent years, various attempts to synthesize polyester, which is used in large quantities, from renewable biomass resources have been made. For example, polyethylene terephthalate (PET) obtained using ethylene glycol derived from biomass resources as a raw material (Patent Literature (PTL) 1) and polyester obtained using 1,3-propanediol and 1,4-butanediol derived from biomass resources as raw materials (PTL 2) have been reported.

### CITATION LIST

### Patent Literature

PTL 1: WO2013/035559
PTL 2: WO2012/115084

### SUMMARY OF INVENTION

### Technical Problem

However, with the polyesters reported in PTL 1 and PTL 2, it is difficult to achieve the required levels of heat resistance and mechanical properties, for example, in applications in which high levels of heat resistance and mechanical properties are required.

A primary object of the present invention is to provide a polyester film that contains a component derived from a biomass raw material, which is environmentally friendly, and also achieves various properties at high levels.

### Solution to Problem

The present inventors conducted extensive research to achieve the above object and found that a polyester film comprising a polyester that comprises a diol unit containing an ethylene glycol unit derived from a biomass raw material and a dicarboxylic acid unit containing a naphthalenedicarboxylic acid unit can achieve various properties at high levels. The inventors conducted further research based on this finding and accomplished the present invention.

The present invention includes the following embodiments.

### Item 1

A polyester film comprising a polyester that comprises a diol unit containing an ethylene glycol unit derived from a biomass raw material and a dicarboxylic acid unit containing a naphthalenedicarboxylic acid unit.

### Item 2

The polyester film according to Item 1, wherein the proportion of the polyester is 1 to 100 mass % based on the total resin amount contained in the polyester film.

### Item 3

The polyester film according to Item 1 or 2, which is stretched in at least one direction.

### Item 4

The polyester film according to Item 1 or 2, for use in any of the following (1) to (13):
(1) an electrical insulation film,
(2) a flexible circuit board,
(3) a flexible circuit board cover film,
(4) a film capacitor,
(5) a polarizing element protective film,
(6) a surface protection film for displays,
(7) a high-barrier substrate,
(8) a film for foldable displays,
(9) an insulation film for motors,
(10) a membrane touch switch substrate,
(11) a gasket for fuel cells,
(12) a magnetic tape substrate, and
(13) a decorative film.

### Advantageous Effects of Invention

The present invention can achieve a polyester film that contains a component derived from a biomass raw material, which is environmentally friendly, and also exhibits various properties at high levels. The present invention can provide polyester films suitable for various applications such as the following:
(1) an electrical insulation film,
(2) a flexible circuit board,
(3) a flexible circuit board cover film,
(4) a film capacitor,
(5) a polarizing element protective film,
(6) a surface protection film for displays,
(7) a high-barrier substrate,
(8) a film for foldable displays,
(9) an insulation film for motors,
(10) a membrane touch switch substrate,
(11) a gasket for fuel cells,
(12) a magnetic tape substrate, and
(13) a decorative film.

### BRIEF DESCRIPTION OF DRAWINGS

FIG. 1 is a schematic diagram to illustrate a method for measuring the hold angle in the bending direction.

FIG. 2 is an enlarged schematic diagram of a sample film in a state in which it is interposed between two PTFE plates.

### DESCRIPTION OF EMBODIMENTS

Typical embodiments of the present invention are described in detail below.

The polyester film of the present invention is characterized by comprising a polyester that comprises a diol unit containing an ethylene glycol unit derived from a biomass raw material and a dicarboxylic acid unit containing a naphthalenedicarboxylic acid unit (sometimes referred to below as “bio-PEN”).

In the present specification, biomass refers to organic resources derived from living organisms, such as animals and plants, excluding fossil resources. Examples of biomass include waste resources, unused resources, production resources, and the like. Examples of waste resources include livestock excrement, food waste, waste paper, black liquor (pulp mill waste), sewage sludge, human waste sludge, wood derived from construction, remaining materials from lumber mills, and the like. Examples of unused resources include rice straw, wheat straw, chaff, bagasse, forest residue, and the like. Examples of production resources include carbohydrate resources, such as sugar cane, starch resources, such as corn, oil and fat resources, such as palm oil and rapeseed oil, willow, poplar, switchgrass, and the like.

The diol unit of the bio-PEN is derived from a diol component containing ethylene glycol derived from a biomass raw material. The ethylene glycol derived from a biomass raw material is preferably produced from, for example, ethanol produced using biomass as a raw material (biomass ethanol). In one embodiment, the biomass is preferably a carbohydrate resource, such as sugar cane. For example, the ethylene glycol derived from a biomass raw material can be obtained by a method of producing ethylene glycol via ethylene oxide from biomass ethanol by a known method. Commercially available ethylene glycol derived from a biomass raw material may also be used. For example, ethylene glycol derived from a biomass raw material commercially available from, for example, India Glycols Ltd., Greencol Taiwan Corporation, etc. can be suitably used.

The diol component is not particularly limited as long as it contains ethylene glycol derived from a biomass raw material. For example, the ethylene glycol in the diol component may be only ethylene glycol derived from a biomass raw material or may be a combination of ethylene glycol derived from a biomass raw material and ethylene glycol derived from a fossil raw material. The diol component may further contain a diol component other than ethylene glycol. Examples of such a diol component other than ethylene glycol include diethylene glycol, 1,2-propanediol, 1,3-propanediol, 1,4-butanediol, 1,4-cyclohexanediol, 1,6-hexanediol, dimerdiol, combinations of two or more of these, and the like.

The content of the ethylene glycol derived from a biomass raw material in the diol component is preferably 80 mols or more, more preferably 85 mol % or more, even more preferably 90 mol % or more, and still even more preferably 95 mol % or more. The content may be, for example, 100 mol % or less, 99.9 mol % or less, 99.5 mol % or less, or 99 mol % or less. The content may be, for example, in the range of 80 to 100 mol %.

The dicarboxylic acid unit of bio-PEN is derived from a dicarboxylic acid component containing naphthalenedicarboxylic acid and/or an ester-forming derivative thereof. Naphthalenedicarboxylic acid includes isomers such as 2,6-, 2,7-, 1,4-, 1,5-, and 1,6-isomers. From the viewpoint of the properties of the polymer formed and cost, it is preferable to use 2,6-naphthalenedicarboxylic acid and/or an ester-forming derivative thereof. The dicarboxylic acid component may further contain a dicarboxylic acid component other than naphthalenedicarboxylic acid and an ester-forming derivative thereof. Examples of such a dicarboxylic acid component other than naphthalenedicarboxylic acid and an ester-forming derivative thereof include terephthalic acid, isophthalic acid, 4,4′-diphenyldicarboxylic acid, adipic acid, sebacic acid, dimer acid, ester-forming derivatives of these, combinations of two or more of these, and the like. In the present specification, the ester-forming derivative is a lower alkyl ester of a dicarboxylic acid (wherein the lower alkyl is C_{1-ϵ} alkyl or the like, and may be optionally substituted with a substituent, such as a hydroxy group), an anhydride, a halide (e.g., chloride), or the like, and a methyl ester, an ethyl ester, a hydroxyethyl ester, etc. can be preferably used.

The content of the naphthalenedicarboxylic acid and/or an ester-forming derivative thereof in the dicarboxylic acid component is preferably 80 mol % or more, more preferably 85 mol % or more, even more preferably 90 mol % or more, and still even more preferably 95 mol % or more. The content may be, for example, 100 mol % or less, 99.9 mol % or less, 99.5 mol % or less, or 99 mol % or less. The content may be, for example, in the range of 80 to 100 mol %.

In one embodiment, the bio-PEN is preferably a polyester comprising an ethylene glycol unit derived from a biomass raw material and a 2,6-naphthalenedicarboxylic acid unit (sometimes referred to below as “bio-2,6-PEN”).

The polyester film of the present invention may further comprise a resin other than the bio-PEN. Examples of resins other than the bio-PEN include polyesters other than the bio-PEN, olefin resins, acrylic resins, styrene resins, polycarbonate resins, polyurethane resins, epoxy resins, combinations of two or more of these, and the like. Among these, polyesters other than the bio-PEN are preferable. Examples of polyesters other than the bio-PEN include polyesters comprising an ethylene glycol unit that does not contain ethylene glycol derived from a biomass raw material, and a naphthalenedicarboxylic acid unit (PEN), polyethylene terephthalate (PET), polybutylene terephthalate (PBT), polybutylene naphthalate (PBN), polypropylene terephthalate (PPT), and the like. Among these, PEN other than the bio-PEN, such as PEN derived only from a fossil raw material (sometimes referred to below as “PEN derived from a fossil raw material”) is preferably used.

The proportion of the bio-PEN (in particular, bio-2,6-PEN) based on the total resin amount contained in the polyester film of the present invention is preferably 1 to 100 mass %. In the present specification, “A to B” means A or more and B or less. The proportion is preferably 5 mass % or more, more preferably 10 mass; or more, and even more preferably 20 mass; or more. The proportion may be, for example, 30 mass % or more, 40 mass or more, 50 mass % or more, 60 mass % or more, 70 mass % or more, or 80 mass % or more. Further, the proportion may be, for example, 99 mass or less, 95 mass or less, or 90 mass % or less. When the polyester film of the present invention comprises bio-PEN and optionally PEN derived from a fossil raw material, the proportion of the bio-PEN based on the total amount of the bio-PEN and the PEN derived from a fossil raw material can be selected from the same range as above (e.g., 1 to 100 mass %).

In the present specification, the biomass degree is defined as an index showing the proportion of the component derived from a biomass raw material among the components constituting the polymer. That is, the biomass degree is the mass proportion that the component derived from a biomass raw material accounts for of the components constituting the polymer. For example, when 100% biomass raw material-derived ethylene glycol is used as the diol component, and 100% fossil raw material-derived naphthalenedicarboxylic acid is used as the dicarboxylic acid component, the biomass degree is calculated as follows from the molecular weights of the monomer units in the polyester produced.

$$\{ ( Molecular weight of ethylene glycol unit 60 \times 100 \% ) + ( Molecular weight of naphthalenedicarboxylic acid unit 182 * 0 \% ) \} \text{} / ( 60 + 182 ) * 100 = 24.8 \%$$

The biomass degree of the total resin is the mass proportion of the component derived from a biomass raw material in the total resin. For example, when equal amounts of bio-PEN with a biomass degree of 24.8% and a resin with a biomass degree of 0% are mixed to make the total resin, the biomass degree of the total resin is 12.4%. The biomass degree of the total resin is preferably 0.2 to 100%, more preferably 1 to 100%, and particularly preferably 5 to 100%.

In the production of the polyester film of the present invention, the intrinsic viscosity of at least one or more types of resin pellets is preferably in the range of 0.4 to 1 dl/g. An intrinsic viscosity of 0.4 dl/g or more is preferable because the impact resistance of the resulting film is improved, and the internal circuit of a display is less likely to break due to an external impact. An intrinsic viscosity of 1 dl/g or less is preferable because it prevents filtration pressure of the molten fluid from becoming too high, thus making it easier to stably perform film production.

For example, the intrinsic viscosity of at least one or more types of resin pellets may be 0.5 to 0.8 dl/g, or 0.55 to 0.7 dl/g.

The polyester film of the present invention may also contain a recycled polymer obtained by pulverizing, drying, and melt-extruding a used film (e.g., a polyester film containing bio-PEN) or a film portion that is generated in the film formation process and cannot be commercialized. Incorporating a recycled polymer allows for further reduction of the environmental burden, which is preferable. The proportion of the recycled polymer may be, for example, 70 mass % or less, 65 mass % or less, 60 masse or less, 55 mass % or less, or 50 mass or less, based on the total resin amount in the polyester film of the present invention. The proportion may also be, for example, 1 mass % or more, 5 mass % or more, or 10 mass or more.

The thickness of the polyester film of the present invention is preferably 1 μm or more and less than 300 μm, and more preferably 3 μm or more and 275 μm or less. A thickness of 1 μm or more prevents, for example, tearing during film formation, and a thickness of 300 μm or less enables the film to be excellent in terms of thickness variation. The thickness can be measured, for example, by a method described in the Examples below.

The polyester film of the present invention may contain inert particles in the polyester in order to improve handling. Inert particles may be contained in the bio-PEN, but are preferably contained in a polyester other than the bio-PEN. The inert particles may be inorganic particles or organic particles. Examples of inorganic particles include spherical silica, aluminum silicate particles, titanium dioxide particles, calcium carbonate particles, agglomerated silica particles, and the like. Examples of organic particles include crosslinked polystyrene resin particles, crosslinked silicone resin particles, crosslinked acrylic resin particles, crosslinked styrene-acrylic resin particles, crosslinked polyester particles, polyimide particles, melamine resin particles, and the like. One type of inert particles may be used or two or more types of inert particles may be used in combination.

The average particle size of the inert particles is preferably 0.01 μm or more and 3 μm or less, more preferably 0.05 μm or more and 2 μm or less, and particularly preferably 0.1 μm or more and 1.5 μm or less. The average particle size can be measured, for example, by a method described in the Examples below.

There are methods for adding inert particles to a resin, including a method in which particles are added to a portion of a component constituting a resin to form a slurry and polymerization is performed and a method in which particles are added using a twin-screw extruder after polymerization of a resin, and any of these methods can be used. The amount of inert particles added is preferably 0.001% or more and 2% or less, more preferably 0.01% or more and 1% or less, and particularly preferably 0.1% or more and 0.8% or less, based on the total mass of the film.

When a hard coating layer or the like is provided over the polyester film of the present invention, the surface of the polyester film can be subjected to treatment for improving adhesion with a resin for forming, for example, a hard coating layer.

Examples of surface treatment methods include unevenness-forming treatment by sandblasting, solvent treatment, etc.; and oxidation treatment, such as corona discharge, electron beam irradiation, plasma treatment, ozone-UV irradiation, flame treatment, chromic-acid treatment, and hot-air treatment. These methods can be used without any limitation.

Adhesion to a hard coating layer or the like can be improved by providing an adhesion-improving layer, such as an adhesion-facilitating layer, over the polyester film of the present invention. For the adhesion-facilitating layer, resins such as acrylic resins, polyester resins, polyurethane resins, and polyether resins can be used without any limitation. The adhesion-facilitating layer can be formed by a typical coating technique, preferably an “in-line coating technique.” For applications requiring particularly high transparency, such as display applications, generally used is a method in which a coating layer is provided on the film surface, and inert particles are incorporated into the layer, without adding inert particles into the polyester resin, thereby improving handling.

The layer structure of the polyester film of the present invention is not limited and may be a single layer or a laminated structure of two or more layers, depending on the use.

The polyester film of the present invention is preferably stretched in at least one direction.

The polyester film of the present invention can be produced by a known method. The polyester film of the present invention can be produced, for example, by forming a resin composition comprising a polyester obtained by polymerization of a diol component containing ethylene glycol derived from a biomass raw material and a dicarboxylic acid component containing naphthalenedicarboxylic acid and/or an ester-forming derivative thereof (bio-PEN) into a film. Specifically, the polyester film of the present invention can be produced, for example, by a method comprising step A of extruding a resin composition comprising bio-PEN from a die into a sheet form using a single extruder or laminating a resin composition comprising bio-PEN and a different resin composition in a molten state and then extruding the laminate from a die into a sheet form, using two or more extruders, and cooling and solidifying the obtained sheet to form a single-layer or laminated unstretched polyester film, step B of stretching the unstretched polyester film (preferably in one direction or two orthogonal directions) as necessary, and step C of further subjecting the stretched polyester film to heat treatment as necessary.

In step A, the temperature at which the resin composition or the laminate is extruded in a molten state is not particularly limited as long as there is no unmelted material and no excessive thermal resin degradation occurs. For example, the extrusion is preferably performed at a temperature in the range of the melting point of the resin (Tm; ° C.) to (Tm+70° C.) In one embodiment, the temperature is preferably 270 to 340° C. For cooling, in order to maintain the flatness of the obtained unstretched polyester film and reduce thickness variation, it is preferable to cool the sheet by bringing it into close contact with a rotating cooling drum disposed below the die along the film-forming direction. The cooling temperature is preferably (Tg-80° C.) to (Tg-60° C.), wherein Tg (° C.) is the glass transition temperature of the resin. In one embodiment, the cooling temperature is preferably 40 to 60° C.

Step B is preferred in that a polyester film having a desired thickness and Young's modulus can be produced and that more excellent processability at high temperatures can be exhibited. The stretching method is not particularly limited, and examples include longitudinal uniaxial stretching, transverse uniaxial stretching, sequential biaxial stretching, simultaneous biaxial stretching, and the like. Longitudinal uniaxial stretching is stretching in which transverse stretching is omitted from sequential biaxial stretching, transverse uniaxial stretching is stretching in which longitudinal stretching is omitted from sequential biaxial stretching, and simultaneous biaxial stretching is stretching in which longitudinal stretching and transverse stretching are simultaneously performed. In sequential biaxial stretching, it is preferable to stretch the unstretched polyester film in a uniaxial direction (generally the longitudinal direction) in a ratio of 1.2-fold or more, preferably 1.4-fold or more, at a temperature of (Tg-10° C.) to (Tg+60° C.), wherein Tg is the glass transition temperature of the resin, and then stretch the film in a direction orthogonal to the stretching direction in a ratio of 2-fold or more, preferably 2.5-fold or more, at a temperature of Tg to (Tg+60)° C. Further, if necessary, the film may be stretched again in the longitudinal direction and/or the transverse direction.

In step C, the stretched polyester film is preferably subjected to heat treatment (heat fixation) at a temperature of, for example, (Tm-90)° C. to (Tm-10° C.), wherein Im is the melting point of the resin. In one embodiment, the heat treatment temperature (heat fixation temperature) is preferably 180 to 260° C. The heat fixation time is preferably 0.1 to 60 seconds.

In the present invention, in order to improve the adhesion between the polyester film and the hard coating layer or the like, or to improve handling, it is also preferred that a coating layer is laminated on at least one surface of the polyester film of the present invention.

Examples of resins to be contained in the coating liquid for use in the coating layer include polyester-based resins, polyurethane resins (e.g., polyether polyurethane resins, polyester polyurethane resins, and polycarbonate polyurethane resins), acrylic resins, and the like; these resins can be used without any particular limitation. Examples of crosslinking agents to be contained in the coating liquid include melamine compounds, isocyanate compounds, oxazoline compounds, epoxy compounds, carbodiimide compounds, and the like. These crosslinking agents may be used singly or in a combination of two or more. Due to the nature of in-line coating, these are preferably applied in the form of an aqueous coating liquid, and the resins and the crosslinking agents are preferably water-soluble or water-dispersible resins or compounds.

To impart smoothness to the coating layer, it is preferable to add particles. In order to prevent the particles from dropping from the coating layer, the particles preferably have an average particle size of 2 μm or less. The particles to be contained in the coating layer may be inorganic particles or organic particles. Examples of inorganic particles include titanium oxide, barium sulfate, calcium carbonate, calcium sulfate, silica, alumina, talc, kaolin, clay, calcium phosphate, mica, hectorite, zirconia, tungsten oxide, lithium fluoride, calcium fluoride, and the like. Examples of organic particles include organic polymer-based particles, such as styrene-based particles, acrylic-based particles, melamine-based particles, benzoguanamine-based particles, and silicone-based particles. These may be singly added to the coating layer or added in a combination of two or more types to the coating layer.

The method for applying the coating liquid may be a known method. Examples include reverse roll coating, gravure coating, kiss coating, roll brush, spray coating, air-knife coating, wire-bar coating, pipe doctor, and the like. These methods may be used singly or in combination.

The coating layer can be obtained, for example, by applying a coating liquid for forming a coating layer to one or both surfaces of an unstretched or longitudinal, uniaxially stretched film, optionally performing heat treatment to dry the applied coating, and further stretching the film in at least one direction, and it is also preferred that the coating layer is formed by performing heat treatment after stretching.

The polyester film comprising bio-PEN of the present invention exhibits excellent properties in terms of heat resistance, mechanical properties, and electrical properties, as in a polyester film comprising PEN derived from a fossil raw material.

The polyester film of the present invention is suitably used in various parts, such as a surface protection film, a polarizer, a retardation film, a touchscreen substrate, a substrate of display cells such as organic EL, and protective materials on the back. In particular, since the polyester film of the present invention is less likely to deform after repeated folding of the polyester film in a high temperature range and image distortion at the folding portion of the display can be suppressed, the polyester film of the present invention is suitably used as a film for foldable displays. The polyester film of the present invention is suitably used in various parts, such as a surface protection film, a polarizer, a retardation film, a touchscreen substrate, a substrate of display cells such as organic EL, and protective materials on the back, in foldable displays. A mobile device equipped with a foldable display comprising the polyester film of the present invention provides beautiful images and has a variety of functions, while being highly convenient, such as in terms of portability. The polyester film of the present invention for use in such applications preferably has a thickness of 10 μm or more and 125 μm or less, a total light transmittance of 85% or more, and a high-temperature hold angle in a bending direction of 60° or more. In the present specification, the high-temperature hold angle refers to an angle of a crease formed after fixing the polyester film at a heating temperature of 85° C. for 18 hours in such a manner that a strain of 1.7% is applied to both surfaces of the polyester film at a bent portion. The bending direction refers to a direction that is orthogonal to a folding portion. The high-temperature hold angle in the bending direction is preferably 65° or higher, more preferably 70° or higher. A higher high-temperature hold angle in the bending direction is preferable, and 180° is most preferred. However, the high-temperature hold angle in the bending direction may be 180° or less. For example, even a high-temperature hold angle of 170° or less also provides sufficient functionality. When the high-temperature hold angle in the bending direction is within the range described above, deformation at high temperatures, such as 85° C., can be suppressed. The total light transmittance and the high-temperature hold angle in the bending direction can be measured by, for example, methods described in the Examples below.

The polyester film of the present invention can have a high elastic modulus, has excellent handling when made into a thin film, and can have a low coefficient of humidity expansion in the width direction, which is important when used as, for example, a magnetic tape substrate. Thus, the polyester film of the present invention can be suitably used as a magnetic tape substrate. In terms of exhibiting excellent dimensional stability, the coefficient of humidity expansion (αh) in the width direction of the polyester film of the present invention is preferably 6 ppm/% RH or less (e.g., 4 ppm/& RH or more and 6 ppm/% RH or less). The coefficient of humidity expansion in the width direction can be measured, for example, by a method described in the Examples below.

The polyester film of the present invention has excellent heat resistance and a high electrical breakdown voltage. Thus, the polyester film of the present invention can be suitably used as an electrical insulation film. The polyester film of the present invention can also be suitably used for applications such as slot liners and wedges for automobile drive motors.

The polyester film of the present invention can have a high in-plane refractive index anisotropy (retardation) and can be suitably used as a polarizer that does not cause rainbow unevenness when mounted in a liquid crystal display device as a thin polarizing element protective film. The film thickness range for this application is preferably 25 to 50 μm, and more preferably 30 to 45 μm.

The polyester film of the present invention has excellent hot-water resistance, a small oxygen gas permeability coefficient, and sufficient vibration durability as a reinforcing member for a polymer electrolyte membrane of a solid polymer electrolyte fuel cell. Thus, the polyester film of the present invention can be suitably used as the reinforcing material.

The polyester film of the present invention has excellent hot-water resistance at high temperatures and a small oxygen permeability coefficient, and therefore can maintain gas sealing properties when used as an electrolyte membrane reinforcing material for solid polymer electrolyte fuel cells. Thus, the polyester film of the present invention can be suitably used as an electrolyte membrane reinforcement film for solid polymer electrolyte fuel cells.

The polyester film of the present invention has a small curl value when heated, making it easy to maintain flatness in a processing process as a membrane touch switch, and also has excellent durability at high temperatures when used as such a switch. Thus, the polyester film of the present invention can be particularly suitably used as a membrane touch switch for use in automobiles.

The polyester film of the present invention has a high glass transition temperature and high degree of anticorrosive properties, and so even if due to sharp mechanical stimulation after bonding to a decorative paint replacement film steel sheet, the paint replacement film itself cracks, rust is unlikely to be formed on metal parts from the cracks, and further rust is unlikely to spread to the surrounding area. Thus, the polyester film of the present invention can be suitably used for applications such as exterior automobile parts.

The polyester film of the present invention has an extremely small heat shrinkage and can therefore be suitably used as a film for flexible circuit boards having excellent via connection reliability.

The polyester film of the present invention has a high breakdown voltage and a low dielectric loss tangent at high temperatures, and can be made thinner. Thus, the polyester film of the present invention can be suitably used as a film for film capacitors having a film thickness of 1 to 5 μm.

The polyester film of the present invention has excellent gas barrier properties and can therefore be suitably used in applications requiring barrier properties, such as a barrier film for protecting organic EL.

The polyester film of the present invention has properties suitable for any of the following applications (1) to (25), preferably any of the following applications (1) to (13), and can be suitably used for these applications:
(1) an electrical insulation film,
(2) a flexible circuit board,
(3) a flexible circuit board cover film,
(4) a film capacitor,
(5) a polarizing element protective film,
(6) a surface protection film for displays,
(7) a high-barrier substrate,
(8) a film for foldable displays,
(9) an insulation film for motors,
(10) a membrane touch switch substrate,
(11) a gasket for fuel cells,
(12) a magnetic tape substrate,
(13) a decorative film,
(14) a back grinding tape,
(15) a dicing tape,
(16) a printed circuit board
(17) a ceramic capacitor release film,
(18) a release film for laminated electronic substrates,
(19) an optical film for backlight
(20) a luminance-improving film
(21) a touchscreen substrate,
(22) a quantum dot sheet substrate film,
(23) a light-controlling glass substrate,
(24) a photographic film, and
(25) a film for metal bonding.

### EXAMPLES

The present invention is described in detail below with reference to Examples and Comparative Examples. However, the present invention is not limited to these Examples. In the present invention, the properties were measured and evaluated by the following methods.

### (1) Thickness

The thickness was measured at 10 points on a film with a multipoint electronic micrometer, and the average value was calculated.

### (2) Total Light Transmittance

The total light transmittance was measured with a haze meter (NDH5000, produced by Nippon Denshoku Industries Co., Ltd.).

### (3) 35° C. Hold Angle

The depth of a crease formed after fixing a film in such a manner that a strain of 1.7% is applied to both surfaces of the film at a bent portion was evaluated.

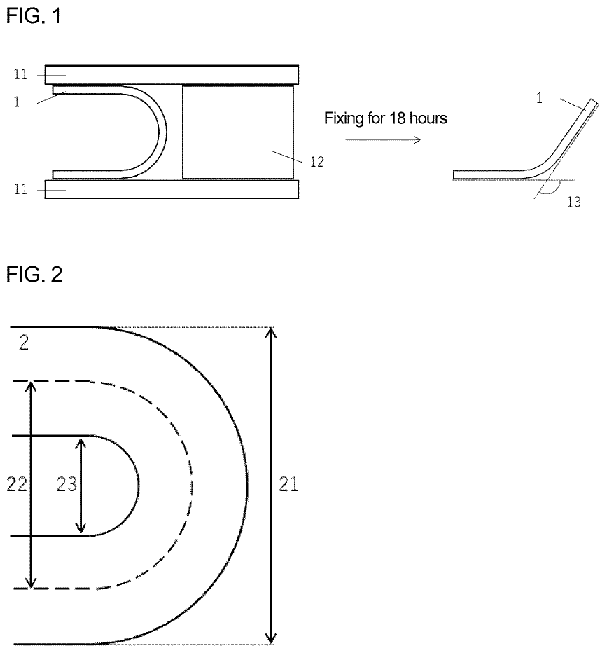

FIG. 1 is a schematic diagram to show a method for measuring the hold angle in the bending direction. A sample film (reference numeral 1) was cut to a size of 10 mm in the width direction and 50 mm in the flow direction. Two PTFE plates (reference numeral 11) were stacked one on the other. In the case of a 50 μm sample film, a PTFE plate with a thickness of 3 mm (reference numeral 12) was inserted as a spacer between the two PTFE plates to form a space between them. Double-sided tape was applied to both ends of the sample film. The sample film in a bent state was inserted into the space of 3 mm between the PTFE plates, and both ends of the sample were fixed to the PTFE plates with the double-sided tape. After the sample film in this state was placed in a dry environment of 85° C. for 18 hours, the sample film was removed from the space between the two PTFE plates (reference numeral 11). Five minutes after the removal, the angle of the crease formed on the film (reference numeral 13) was measured. This angle is defined as the high-temperature hold angle.

FIG. 2 is an enlarged schematic diagram of a sample film (reference numeral 2) interposed between two PTFE plates (reference numeral 11 in FIG. 1). A neutral plane to which neither compressive stress nor tensile stress is applied is defined as the center in the thickness direction (the dashed line in the figure), and the difference between the neutral plane and both surfaces is defined as strain.

In FIG. 2, reference numeral 21 indicates the diameter of the outermost surface of the sample film, reference numeral 22 indicates the diameter of the neutral plane of the sample film, and reference numeral 23 indicates the diameter of the innermost surface of the sample film.

In the evaluation of the high-temperature hold angle, strain (1.7%) can be expressed according to the following method.

$$Strain ( 1.7 \% ) = ( \vert Semi - circumference of the outermost surface or the innermost surface - Semi - circumference of the neutral plane \vert \text{} / Semi - circumference of the neutral plane ) \times 100$$

When the thickness of a sample film is defined as t (mm) and the bend diameter (diameter of the outermost surface), i.e., the thickness of the spacer used, is defined as d (mm), the semi-circumferences can be determined according to the following formulas.

$$Semi - circumference of the outermost surface = d \times π / 2$$

$$Semi - circumference of the neutral plane = ( d - t ) \times π / 2$$

$$Semi - circumference of the innermost surface = ( d - 2 t ) \times π / 2$$

From the above, when the strain is set to 1.7%, the thickness of the sample film is defined as t (mm), and the bend diameter, i.e., the thickness of the spacer used, is defined as d (mm), the thickness of the spacer (PTFE plate) used is determined according to the following formula. The spacer thickness relative to typical film thickness can be shown, for example, as below.

$$Spacer thickness d ( mm ) = film thickness t ( mm ) \times 60$$

For example, when the sample film has a thickness of 50 μm, the diameter of the outermost surface (reference numeral 21) is the same as the thickness d of the spacer, which is 3 mm. The diameter of the innermost surface (reference numeral 23) is 2.9 mm, and the diameter of the neutral plane (reference numeral 22) is 2.95 mm. In the above formula that shows strain, the semi-circumference of the outermost surface and the semi-circumference of the innermost surface can be appropriately selected.

### (4) Density

Density was measured in accordance with the method described in JIS K 7112:1999 (density-gradient tube method) (unit: g/cm³).

### (5) Heat Shrinkage

A sample film was cut to a size of 10 mm×250 mm, and a long side was aligned with the direction to be measured and marked at intervals of 200 mm. Distance A, which is a distance between the marks, was measured under a constant tension of 5 g. Subsequently, the sample film was allowed to stand in an atmosphere at a predetermined temperature in an oven for 30 minutes or 10 minutes without a load, and then removed from the oven, followed by cooling to room temperature. Thereafter, distance B, which is a distance between the marks, was measured under a constant tension of 5 g, and the heat shrinkage (%) was determined according to the following formula. The measurement was performed three times in the same direction, and the average value was defined as the heat shrinkage (%).

$$Heat shinkage ( \% ) = [ ( A - B ) \times 100 ] / A$$

### (6) Elastic Modulus

A film was cut to a size of 10 mm (width) and 15 cm (length) and pulled with a universal tensile tester (trade name: Tensilon, produced by Toyo Baldwin Co., Ltd.) under the conditions of a chuck-to-chuck distance of 100 mm and a tensile rate of 100 mm/min. The elastic modulus was calculated from the slope of the tangent line at the rising portion of the obtained load-elongation curve, and the cross-sectional area of the film.

### (7) Coefficient of Humidity Expansion

A film was cut to a size of 15 mm (length) and 5 mm (width) so that the transverse direction was the measurement direction. The length of each sample was measured with a Bruker AXS humidity-controlled thermomechanical analyzer (TMA4000SA, MTC-1000SA) at a temperature of 30° C., and a humidity of 30% RH and a humidity of 70% RH, and the coefficient of humidity expansion was calculated using the following formula. The measurement direction was the longitudinal direction of the cut sample. The measurement was performed five times, and the average value was defined as αh.

$$α h = ( L 70 - L 30 ) / ( L 30 \times Δ H )$$

In the above formula, L30 is the sample length (mm) at 30% RH, L70 is the sample length (mm) at 70% RH, and ΔH is 40 (=70-30) % RH.

### (8) Breakdown Voltage

In accordance with the plate electrode method described in JIS C2151, the voltage was increased at a rate of 1 (KV/sec) with an ITS-6003 (produced by Tokyo Seiden), and the voltage at break of the film was read with a voltmeter to measure the breakdown voltage.

### (9) Intrinsic Viscosity

A film or polyester resin was pulverized, dried, and dissolved in a mixed solvent of phenol and tetrachloroethane in a ratio of phenol to tetrachloroethane of 60/40 (mass ratio). This solution was then centrifuged to remove inorganic particles. The flow time of the solution with a concentration of 0.4 (g/dl) and the flow time of the solvent alone were measured with an Ubbelohde viscometer at 30° C. From the time ratio, the intrinsic viscosity was calculated by using the Huggins equation with the assumption of Huggins's constant being 0.38. The same calculation equation was used for both polyethylene terephthalate (PET) and polyethylene naphthalate (PEN) to perform evaluation.

### (10) Average Particle Size of Particles

The polyester of the surface layer of a film was removed by a low-temperature plasma ashing method (for example, PR-503, produced by Yamato Scientific Co., Ltd.) to expose particles. The treatment conditions selected were those in which the polyester is ashed but the particles are not damaged. The particles were observed with a scanning electron microscope (SEM) at a magnification of about 10000× to 100000×, and the equivalent circle diameters (Di) of at least 1,000 particles were determined by changing the observation site. A particle size distribution curve was prepared, and the most frequently occurring value was taken as the average particle size. When the particle distribution curve had two or more peaks, the particle size at each peak was taken as the average particle size.

### (11) Refractive Index

The refractive index in the MD direction (Nx), the refractive index in the TD direction (Ny), and the refractive index in the thickness direction (Nz) were measured at a wavelength of 633 nm with a Metricon Model 2010/M Prism Coupler.

### (12) Birefringence (ΔNxy) and Retardation (Re)

Retardation is a phase difference expressed by the product of the film thickness d and the birefringence caused by the refractive indexes (Nx, Ny, Nz) in the individual axial directions of a film, i.e., in the thickness direction (z-axis) with respect to the film surface and two axial directions (x-axis and y-axis) that are orthogonal to the thickness direction and orthogonal to each other. Retardation as used herein refers to in-plane retardation that is the product of the birefringence Nxy caused by light incident on the film surface (x-y plane) with the MD direction being the x-axis and the TD direction being the y-axis, and the thickness d. The birefringence and retardation were determined according to the following formulas. As is customary, the unit of retardation is nm.

$$Δ Nxy = \vert Nx - Ny \vert$$

$$Re = Nxy \times d$$

### (13) Observation of Rainbow Unevenness

The film of each of the Examples and Comparative Examples produced by the methods described below was individually bonded to one side of a commercially available polarizing element in such a manner that the main orientation axis of the film (the higher of Nx and Ny) was perpendicular to the absorption axis of the polarizing element, and a commercially available TAC film was bonded to the opposite side of the polarizing element, thereby obtaining a polarizer. The polarizer on the light-outgoing side of a commercially available liquid crystal display device including a white LED as a backlight and a liquid crystal cell sandwiched between polarizers each having two TAC films as polarizing element protective films was removed. Instead of this, the obtained polarizer was disposed so that the film of each of the Examples and Comparative Examples was individually placed on the light-outgoing side. The liquid crystal display device thus produced was visually observed from the front and from an oblique direction, and the occurrence of rainbow unevenness was assessed according to the following criteria.
∘: No rainbow unevenness was observed from any direction.
x: When observed from an oblique direction, rainbow unevenness was clearly observed.

### (14) Hot-Water Resistance

A film was cut to a sample in the form of a strip having a size of 150 mm (length)×10 mm (width) so that the MD direction of the film was the measurement direction, and the sample was hung with a stainless-steel clip in an environmental tester set to 121° C., 2 atm, a wet saturation mode, and 100% RH. Thereafter, the sample was taken out at predetermined time intervals, and the breaking strength in the MD direction of the film was measured. The breaking strength was measured with a Tensilon UCT-100 produced by Orientec Corporation in a room adjusted to a temperature of 20° C. and a humidity of 50% by pulling under the conditions of a chuck-to-chuck distance of 100 mm, a tensile rate of 100 mm/min, and a chart rate of 500 mm/min to determine the strength at break.

The measurement was performed 5 times, the average value was calculated, and the time required for the retention of breaking strength in the MD direction, which is represented by the following formula (1), to reach 50% of the initial value was determined to evaluate hot-water resistance. The measurement device used was a Tensilon UCT-100 produced by Orientec Corporation.

$$Breaking strength retention ( \% ) = ( Breaking strength X / Initial breaking strength X 0 ) \times 100 \qquad ( 1 )$$

In formula (1), the breaking strength X represents the breaking strength (unit: MPa) after treatment for a predetermined time under conditions of 121° C., 2 atm, and 100% RH, and the breaking strength X0 represents the initial breaking strength (unit: MPa) before treatment.

### (15) Oxygen Permeability Coefficient

The oxygen permeability at 25° C. was measured with a gas permeability measuring device (MC-1, produced by Toyo Seiki Seisaku-sho, Ltd.) in accordance with JIS K-7126.

### (16) Evaluation of Reinforcing Performance of Reinforcing Member

A perfluorosulfonic acid resin (Nafion 117, produced by DuPont) in a 100 mm square shape was used as an electrolyte membrane, and a frame-shaped biaxially oriented film (outer periphery: 100 mm×100 mm; inner periphery: 30 mm×80 mm) was stacked on both surfaces of the electrolyte membrane and bonded by heat pressing at 140° C.

The resulting structure of the electrolyte membrane and the reinforcing member was fixed to a vibration tester, and sweep was performed from 10 Hz to 55 Hz and then to 10 Hz for 60 seconds with an amplitude of 0.75 mm (longitudinal direction) under an atmosphere of 90° C. This operation was regarded as one cycle. After performing 10 cycles, the electrolyte membrane was visually observed for changes, such as wrinkles, breakage, and damage, and assessed according to the following criteria.
∘: No changes, such as wrinkles, breakage, or damage, were observed in the electrolyte membrane; thus, the reinforcement performance was excellent.
x: At least one of the following was observed in the electrolyte membrane: wrinkles, breakage, damage; thus the reinforcement performance was insufficient.

### (17) Heat Curl Height

A film sample having a size of 3 cm in the flow direction×20 cm in the width direction in film production was placed on an iron plate, and the iron plate was allowed to stand in an oven set to 180° C. for 5 minutes, removed from the oven, and allowed to cool naturally. Subsequently, the film sample was placed on a glass plate, the heights (vertical direction) of four corners were measured, and the average value was measured. The film was turned over, the same measurement was performed, and the higher value was defined as the heat curl height.

### (18) Evaluation of Membrane Switch Deformation

A film sample was screen-printed with a silver paste as a conductive circuit and with a carbon paste as printing contacts (electrodes) and dried at 140° C. for 20 minutes to prepare a switch sheet. Thereafter, a film-shaped styrene-butadiene resin was used as an adhesive for attaching two of the sheets, and a spacer for a membrane switch.

The obtained membrane switch was subjected to an ON/OFF repetition test in which a load to turn the switch to ON (initial load: for example, 1.5 kg/cm²) is applied and removed repeatedly at 1-minute intervals. This test was performed in 10 cycles to determine the average load (initial load). Thereafter, with the load removed, the membrane switch was placed on an iron plate, and the iron plate was placed in an oven set to 180° C., removed after 5 minutes, and allowed to cool naturally. A load was applied again to the switch, and the ON/OFF repetition test was performed in 10 cycles. The load required to turn the switch to ON (post-treatment load) was measured. This test was performed with n=10, and the average value was determined to make evaluation according to the following criteria.

$$Load change ( \% ) = ( \vert Post - treatment load - Initial load \vert / Initial load ) \times 100$$

∘: The change was 10% or less, and the deformation due to heat treatment was small.
x: The change exceeded 10%, and the deformation due to heat treatment was large.

### (19) Evaluation of Anticorrosive Properties of Decorative Paint Replacement Film

### Production of Decorative Paint Replacement Film

A colored layer was applied to an obtained polyester film with a comma coater. For the colored layer, a solvent paint containing an acrylic urethane-based resin as a binder component and 20 mass of titanium particles as a pigment and having a nonvolatile content of 35 mass % was used. The solvent paint was applied so that the thickness was 20 μm and dried in a drying oven at 90° C., followed by winding.

The polyester film on which the colored layer was applied was unwound, and then, in order to form a hard coating layer, a hard coat paint (HC-1) having a nonvolatile content of mass % described below was applied to a thickness of 15 μm (thickness after curing) with a comma coater and sufficiently dried in a drying oven at 90° C. Before winding, a biaxially stretched film made of a polyethylene terephthalate resin was laminated as a protective film, and the resulting film was wound in a roll shape to obtain a decorative paint replacement film.

### Hard Coat Paint (HC-1)

150 parts by mass of methyl isobutyl ketone (MIBK) was placed in a four-necked flask equipped with a condenser tube, a stirrer, a thermometer, and a nitrogen-feeding tube and heated with stirring in a nitrogen atmosphere. When the temperature inside the flask reached 74° C., the temperature was maintained as a synthesis temperature, and a monomer solution obtained by mixing 3 parts by mass of methyl methacrylate, 82.54 parts by mass of n-butyl methacrylate, 12.85 parts by mass of 4-hydroxybutyl acrylate, 0.61 parts by mass of methacrylic acid, 1 part by mass of Fancryl FA-711 MM (produced by Hitachi Chemical Company, Ltd., pentamethyl piperidinyl methacrylate), and 0.1 parts by mass of azobisisobutyronitrile was added dropwise over a period of 2 hours. From one hour after the completion of the dropwise addition of the monomer, 0.02 parts by mass of azobisisobutyronitrile was added every hour to continue the reaction until the amount of unreacted monomer in the solution became 1 mass % or less. When the amount of unreacted monomer became 1 mass or less, the reaction was ended by cooling to obtain an acrylic copolymer solution having a solids content of about 40 mass. To the acrylic copolymer solution, 59.9 parts by mass (solid mass) of Duranate P301-75E (produced by Asahi Kasei Chemicals Corporation, a polyisocyanate form of hexamethylene diisocyanate; referred to below as “curing agent 1”) was added as a polyisocyanate compound, and further, methyl isobutyl ketone (MIBK) was added so that the solids content was 30 mass %, followed by stirring, thereby obtaining a hard coat paint (HC-1).

### Production of Laminate Steel Sheet

The decorative paint replacement film obtained above was laminated onto a JAC270F45/45 plated steel sheet to produce a laminate steel sheet. Specifically, the decorative paint replacement film was unwound, and the steel sheet was heated to 290° C., guided, and subjected to lamination by thermocompression bonding with the film at a pressure of 0.3 MPa, with a lamination roll brought to room temperature. The laminate steel sheet was rapidly cooled with cooling water to obtain a laminate steel sheet.

### Evaluation of Anticorrosive Properties

Two diagonal lines (scratch marks) each having a length of 10 cm, orthogonal to each other at the center, were drawn on the paint replacement film in the obtained laminate steel sheet with the tip of a utility knife so as to reach the substrate of the steel sheet. The laminate steel sheet was placed in a retort, the retort was filled with 3% acetic acid and 2% saline, and retort treatment was performed with pressurized steam at 125° C. for 90 minutes. The laminate steel sheet was taken out and its condition was visually checked.
∘: In all 10 samples, the steel sheet rusted only at the scratch mark area, but there was no clear spread.
Δ: In any of the 10 samples, clear spread of the rust of the steel sheet at the scratch mark area was observed.
x: In any of the 10 samples, rusting also occurred at other areas in addition to the scratch mark area, and the film was peeling off.

### (20) Heat Cycle Evaluation (Film for Flexible Circuit Boards) Production of Laminate

An Aron Mighty AF-700 thermosetting adhesive sheet (produced by Toagosei Co., Ltd.) was temporarily bonded to both sides of an obtained polyester film at 100° C., and TO-M4-VSP copper foil (produced by Mitsui Mining & Smelting Co., Ltd.) having a thickness of 18 μm was stacked, followed by heat pressing at 180° C. and 1 MPa for 30 minutes, thereby producing a flexible copper-clad laminate.

Vias having a diameter of 0.1 mm were formed in the obtained copper-clad laminate with a drill, the surface was acid-washed, and then the inner surfaces of the vias were subjected to electroless plating to obtain a laminate.

### Heat Cycle Test

The laminate obtained above was subjected to a heat cycle test in accordance with the thermal shock test method of JIS C5016: 1994. The temperature was −55° C. to 100° C., the number of cycles was 100, and the via continuity after the test was evaluated.
∘: No continuity failure in the measurement of 10 samples.
x: One or more continuity failures in the measurement of 10 samples.

### (21) Glass Transition Temperature

The glass transition temperature was determined by a method in which a film was heated from room temperature to a temperature 35° C. higher than the melting point of the unstretched film at a temperature increase rate of 20° C./min, maintained in a molten state at the temperature for 3 minutes, removed, immediately transferred onto ice to rapidly cool, and then heated again at a temperature increase rate of 20° C./min. The Tg reading position is the temperature at the intersection of a straight line obtained by extending the baseline on the lower temperature side to the higher temperature side with a tangent line drawn from the point where the gradient of the curve at the stepwise portion is maximum, in a stepwise change portion of the glass transition on a differential scanning calorimetry chart.

### (22) UV Absorption Performance

A polyester film sample having a size of 8 mm in the width direction (TD)×40 mm in the machine direction (MD) was prepared. The sample was placed so that the machine direction was parallel to the gravity direction, and the transmittance at a wavelength of 360 nm was measured with a spectrophotometer (produced by Shimadzu Corporation, UV1800).

### (23) Breakdown Voltage (BDV) of Film for Capacitors

Measurement was performed according to the method described in JIS-C-2318, and the average value of n=100 was defined as the breakdown voltage (BDV).

(24) Dielectric Loss Tangent (tanδ)

A sample film was adjusted at 23° C. and 50% RH for 16 hours. Thereafter, Al was vapor-deposited on both sides of the film, and the value at 100° C. and 1 kHz was measured using electrodes and a capacitance bridge described in JIS-C-2318.

Polymerization of PEN Resin Derived from Biomass Raw Material, PEN-1

60 parts by mass of ethylene glycol derived from a biomass raw material (produced by India Glycols Ltd.) and 150 parts by mass of naphthalene-2,6-dicarboxylic acid dimethyl ester derived from a fossil raw material were subjected to a transesterification reaction according to a usual method using 0.03 parts by mass of manganese acetate tetrahydrate as a transesterification catalyst, and then 0.042 parts by mass of triethyl phosphonoacetate was added to substantially end the transesterification reaction. Subsequently, 0.024 parts by mass of antimony trioxide was added, and polymerization was continuously performed at high temperature under high vacuum according to a usual method, thereby obtaining a polyethylene-2,6-naphthalene dicarboxylate resin with an intrinsic viscosity of 0.62 dl/g. This resin is referred to as “PEN-1.”

Polymerization of PEN Resin Derived from Fossil Raw Material, PEN-2

60 parts by mass of ethylene glycol derived from a fossil raw material and 150 parts by mass of naphthalene-2,6-dicarboxylic acid dimethyl ester derived from a fossil raw material were subjected to a transesterification reaction according to a usual method using 0.03 parts by mass of manganese acetate tetrahydrate as a transesterification catalyst, and then 0.042 parts by mass of triethyl phosphonoacetate was added to substantially end the transesterification reaction. Subsequently, 0.024 parts by mass of antimony trioxide was added, and polymerization was continuously performed at high temperature under high vacuum according to a usual method, thereby obtaining a polyethylene-2,6-naphthalene dicarboxylate resin with an intrinsic viscosity of 0.62 dl/g. This resin is referred to as “PEN-2.”

Polymerization of PEN Resin Derived from Fossil Raw Material (Containing Lubricant), PEN-3

150 parts by mass of naphthalene-2,6-dicarboxylic acid dimethyl ester derived from a fossil raw material and 60 parts by mass of ethylene glycol derived from a fossil raw material were subjected to a transesterification reaction according to a usual method by using 0.03 parts by mass of manganese acetate tetrahydrate as a transesterification catalyst and adding spherical silica particles having an average particle size of 0.3 μm as a lubricant so that the content of the spherical silica particles was 1 mass %. 0.042 parts by mass of triethyl phosphonoacetate was then added to substantially end the transesterification reaction. Subsequently, 0.024 parts by mass of antimony trioxide was added, and polymerization was continuously performed at high temperature under high vacuum according to a usual method, thereby obtaining a polyethylene-2,6-naphthalene dicarboxylate resin with an intrinsic viscosity of 0.62 dl/g. This resin is referred to as “PEN-3.”

Polymerization of PEN Resin Derived from Fossil Raw Material (Containing Lubricant), PEN-4

150 parts by mass of naphthalene-2,6-dicarboxylic acid dimethyl ester derived from a fossil raw material and 60 parts by mass of ethylene glycol derived from a fossil raw material were subjected to a transesterification reaction according to a usual method by using 0.03 parts by mass of manganese acetate tetrahydrate as a transesterification catalyst and adding spherical silica particles having an average particle size of 0.1 μm as a lubricant so that the content of the spherical silica particles was 1 mass %. 0.042 parts by mass of triethyl phosphonoacetate was then added to substantially end the transesterification reaction. Subsequently, 0.024 parts by mass of antimony trioxide was added, and polymerization was continuously performed at high temperature under high vacuum according to a usual method, thereby obtaining a polyethylene-2,6-naphthalene dicarboxylate resin with an intrinsic viscosity of 0.62 dl/g. This resin is referred to as “PEN-4.”

Polymerization of PEN Resin Derived from Fossil Raw Material (Containing Lubricant), PEN-6

150 parts by mass of naphthalene-2,6-dicarboxylic acid dimethyl ester derived from a fossil raw material and 60 parts by mass of ethylene glycol derived from a fossil raw material were subjected to a transesterification reaction according to a usual method by using 0.03 parts by mass of manganese acetate tetrahydrate as a transesterification catalyst and adding calcium carbonate particles having an average particle size of 0.6 μm as a lubricant so that the content of the calcium carbonate particles was 1 mass. 0.042 parts by mass of triethyl phosphonoacetate was then added to substantially end the transesterification reaction. Subsequently, 0.024 parts by mass of antimony trioxide was added, and polymerization was continuously performed at high temperature under high vacuum according to a usual method, thereby obtaining a polyethylene-2,6-naphthalene dicarboxylate resin with an intrinsic viscosity of 0.62 dl/g. This resin is referred to as “PEN-6.”

Polymerization of PET Resin Derived from Biomass Raw Material, PET-1

60 parts by mass of ethylene glycol derived from a biomass raw material (produced by India Glycols Ltd.) and 100 parts by mass of terephthalic acid dimethyl ester derived from a fossil raw material were subjected to a transesterification reaction according to a usual method using 0.03 parts by mass of manganese acetate tetrahydrate as a transesterification catalyst, and then 0.042 parts by mass of triethyl phosphonoacetate was added to substantially end the transesterification reaction. Subsequently, 0.024 parts by mass of antimony trioxide was added, and polymerization was continuously performed at high temperature under high vacuum according to a usual method, thereby obtaining a polyethylene terephthalate resin with an intrinsic viscosity of 0.62 dl/g. This resin is referred to as “PET-1.”

Polymerization of PET Resin Derived from Fossil Raw Material, PET-2

100 parts by mass of terephthalic acid dimethyl ester derived from a fossil raw material and 60 parts by mass of ethylene glycol derived from a fossil raw material were subjected to a transesterification reaction according to a usual method using 0.03 parts by mass of manganese acetate tetrahydrate as a transesterification catalyst, and then 0.042 parts by mass of triethyl phosphonoacetate was added to substantially end the transesterification reaction. Subsequently, 0.024 parts by mass of antimony trioxide was added, and polymerization was continuously performed at high temperature under high vacuum according to a usual method, thereby obtaining a polyethylene terephthalate resin with an intrinsic viscosity of 0.62 dl/g. This resin is referred to as “PET-2.”

Polymerization of PET Resin Derived from Fossil Raw Material (Containing Lubricant), PET-3

100 parts by mass of terephthalic acid dimethyl ester derived from a fossil raw material and 60 parts by mass of ethylene glycol derived from a fossil raw material were subjected to a transesterification reaction according to a usual method by using 0.03 parts by mass of manganese acetate tetrahydrate as a transesterification catalyst and adding spherical silica particles having an average particle size of 0.3 μm as a lubricant so that the content of the spherical silica particles was 1 mass %. 0.042 parts by mass of triethyl phosphonoacetate was then added to substantially end the transesterification reaction. Subsequently, 0.024 parts by mass of antimony trioxide was added, and polymerization was continuously performed at high temperature under high vacuum according to a usual method, thereby obtaining a polyethylene terephthalate resin with an intrinsic viscosity of 0.62 dl/g. This resin is referred to as “PET-3.”

Polymerization of PET Resin Derived from Fossil Raw Material (Containing Lubricant), PET-4

100 parts by mass of terephthalic acid dimethyl ester derived from a fossil raw material and 60 parts by mass of ethylene glycol derived from a fossil raw material were subjected to a transesterification reaction according to a usual method by using 0.03 parts by mass of manganese acetate tetrahydrate as a transesterification catalyst and adding spherical silica particles having an average particle size of 0.1 μm as a lubricant so that the content of the spherical silica particles was 1 mass. 0.042 parts by mass of triethyl phosphonoacetate was then added to substantially end the transesterification reaction. Subsequently, 0.024 parts by mass of antimony trioxide was added, and polymerization was continuously performed at high temperature under high vacuum according to a usual method, thereby obtaining a polyethylene terephthalate resin with an intrinsic viscosity of 0.62 dl/g. This resin is referred to as “PET-4.”

Polymerization of PET Resin Derived from Fossil Raw Material (Containing Lubricant), PET-5

100 parts by mass of terephthalic acid dimethyl ester derived from a fossil raw material and 60 parts by mass of ethylene glycol derived from a fossil raw material were subjected to a transesterification reaction according to a usual method by using 0.03 parts by mass of manganese acetate tetrahydrate as a transesterification catalyst and adding calcium carbonate particles having an average particle size of 0.6 μm as a lubricant so that the content of the calcium carbonate particles was 1 massy. 0.042 parts by mass of triethyl phosphonoacetate was then added to substantially end the transesterification reaction. Subsequently, 0.024 parts by mass of antimony trioxide was added, and polymerization was continuously performed at high temperature under high vacuum according to a usual method, thereby obtaining a polyethylene terephthalate resin with an intrinsic viscosity of 0.62 dl/g. This resin is referred to as “PET-5.”

### Preparation of Coating Liquid for Forming Adhesion-facilitating Layer

### Polymerization of Urethane Resin

72.96 parts by mass of 1,3-bis(methylisocyanate) cyclohexane, 12.60 parts by mass of dimethylol propionic acid, 11.74 parts by mass of neopentyl glycol, 112.70 parts by mass of polycarbonate diol with a number average molecular weight of 2000, and as solvents, 85.00 parts by mass of acetonitrile and 5.00 parts by mass of N-methylpyrrolidone were placed in a four-necked flask equipped with a stirrer, a Dimroth condenser, a nitrogen-feeding tube, a silica-gel-drying tube, and a thermometer, and stirred in a nitrogen atmosphere at 75° C. for 3 hours; the reaction mixture was confirmed to have reached a predetermined amine equivalent. Subsequently, after the reaction mixture was cooled to 40° C., 9.03 parts by mass of triethyl amine was added, thereby obtaining a polyurethane prepolymer D solution. 450 g of water was then added to a reactor equipped with a homogenizing disperser capable of high-speed stirring, and the temperature was adjusted to 25° C., followed by dispersing an isocyanate-terminated prepolymer in water with stirring at 2000 rpm. Thereafter, some acetonitrile and water were removed under reduced pressure, thereby preparing a water-soluble polyurethane resin (A) with a solids content of 35 mass %.

### Polymerization of Water-soluble Carbodiimide Compound

200 parts by mass of isophorone diisocyanate and 4 parts by mass of 3-methyl-1-phenyl-2-phosphorene-1-oxide (carbodiimidized catalyst) were added to a flask equipped with a thermometer, a nitrogen-gas-feeding tube, a reflux condenser, a dropping funnel, and a stirrer, and stirred in a nitrogen atmosphere at 180° C. for 10 hours, thereby obtaining an isocyanate-terminated isophorone carbodiimide (degree of polymerization: 5). Subsequently, 111.2 g of the obtained carbodiimide and 80 g of polyethylene glycol monomethyl ether (molecular weight: 400) were reacted at 100° C. for 24 hours. Water was gradually added thereto at 50° C., thereby obtaining transparent yellowish water-soluble carbodiimide compound (B) with a solids content of 40 mass %.

### Preparation of Coating Liquid for Forming Adhesion-facilitating Layer

The following coating materials were mixed, thereby preparing a coating liquid.
Water: 16.97 parts by mass
Isopropanol: 21.96 parts by mass
Polyurethane resin (A): 3.27 parts by mass
Water-soluble carbodiimide compound (B): 1.22 parts by mass Particles: 0.51 parts by mass
(silica sol with an average particle size of 40 nm, solids concentration: 40 mass %)
Surfactant: 0.05 parts by mass
(silicone-based surfactant, solids concentration: 100 mass %)

### Example 1-1

PEN-1 pellets were supplied to an extruder and melted at 300° C. The molten polymer was filtered through a sintered stainless-steel filter material (nominal filtration accuracy: 10 μm particle 95% cut) and extruded from a die into a sheet form. The sheet-form polymer was then brought into contact with a casting drum (surface temperature: 50° C.) by using an electrostatic casting method to solidify the polymer by cooling, thereby preparing an unstretched film. The unstretched film was uniformly heated to 120° C. using heating rolls, heated to a film temperature of 135° C. using an infrared heater disposed between low-speed and high-speed rolls, and stretched in the longitudinal direction at a speed ratio of the low-speed and high-speed rolls of 1.7 times to obtain a uniaxially stretched film. Subsequently, the coating liquid for forming an adhesion-facilitating layer described above was applied to both surfaces of the uniaxially stretched film by roll coating so that the coating amount after drying after biaxial stretching was 0.06 g/m². The film was then guided to a tenter, preheated at 145° C., and stretched 4.5-fold in the transverse direction at 135° C. With the width fixed, the film was subjected to heat fixation at 230° C. for 5 seconds and further relaxed by 1% in the width direction at 180° C., thereby obtaining a polyethylene 2,6-naphthalate film with a thickness of 50 μm. Table 1 shows the properties of the film.

### Examples 1-2 and 1-3

Polyethylene 2,6-naphthalate films were obtained in the same manner as in Example 1-1, except that the stretch ratio for stretching in the longitudinal direction, the heat fixation temperature, and thickness were as shown in Table 1. Table 1 shows the properties of these films.

### Comparative Example 1

A polyethylene 2,6-naphthalate film having a thickness of 50 μm was obtained in the same manner as in Example 1-1, except that the pellets used were PEN-2. Table 1 shows the properties of the film.

### Comparative Example 2

79.4 parts by mass of PET-1 was mixed with 20.6 parts by mass of PET-2, and the mixture was supplied to an extruder and melted at 285° C. The molten polymer was filtered through a sintered stainless-steel filter material (nominal filtration accuracy: 10 μm particle 95% cut) and extruded from a die into a sheet form. The sheet-form polymer was then brought into contact with a casting drum (surface temperature: 30° C.) by using an electrostatic casting method to solidify the polymer by cooling, thereby preparing an unstretched film. The unstretched film was uniformly heated to 75° C. using heating rolls, heated to a film temperature of 85° C. using an infrared heater disposed between low-speed and high-speed rolls, and stretched in the longitudinal direction at a speed ratio of the low-speed and high-speed rolls of 1.4 times to obtain a uniaxially stretched film. Subsequently, the coating liquid for forming an adhesion-facilitating layer described above was applied to both surfaces of the uniaxially stretched film by roll coating so that the coating amount after drying after biaxial stretching was 0.06 g/m². The film was then guided to a tenter, preheated at 105° C., and stretched 4.2-fold in the transverse direction at 100° C. With the width fixed, the film was subjected to heat fixation at 210° C. for 5 seconds and further relaxed by 1% in the width direction at 130° C., thereby obtaining a polyethylene terephthalate film with a thickness of 50 μm. Table 1 shows the properties of the film.

TABLE 1

| | | Ex. | Ex. | Ex. | Comp. | Com. |
|---|---|---|---|---|---|---|
| | | 1-1 | 1-2 | 1-3 | Ex. 1 | Ex. 2 |
| Resin | PEN-1 | 100 | 100 | 100 | — | — |
| proportion | PEN-2 | — | — | — | 100 | — |
| | PEN-3 | — | — | — | — | — |
| | PEN-4 | — | — | — | — | — |
| | PEN-5 | — | — | — | — | — |
| | PET-1 | — | — | — | — | 79.4 |
| | PET-2 | — | — | — | — | 20.6 |
| | PET-3 | — | — | — | — | — |
| | PET-4 | — | — | — | — | — |
| Biomass-derived polymer content (%) | | 100 | 100 | 100 | 0 | 79.4 |
| Biomass degree (%) | | 24.8 | 24.8 | 24.8 | 0 | 24.8 |
| Thickness (μm) | | 50 | 50 | 80 | 50 | 50 |
| Stretch ratio | Longitudinal direction | 1.7 | 1.2 | 1.7 | 1.7 | 1.4 |
| | Transverse direction | 4.5 | 4.5 | 4.5 | 4.5 | 4.2 |
| Heat fixation temperature (° C.) | | 230 | 210 | 230 | 230 | 210 |
| Density (g/cm³) | | 1.351 | 1.351 | 1.351 | 1.351 | 1.385 |
| Heat shrinkage | Longitudinal direction | 0.3 | 0.4 | 0.3 | 0.3 | 1.9 |
| 150° C., 30 min | Transverse direction | 0 | 0 | 0 | 0 | 0.6 |

| | | | | | |
|---|---|---|---|---|---|
| Total light transmittance (%) | 91 | 91 | 91 | 91 | 91 |
| 85° C. hold angle (degrees) | 76 | 76 | 76 | 76 | 31 |

A comparison of Examples 1-1 to 1-3 with Comparative Examples 1 and 2 shows that the films containing polyethylene 2,6-naphthalate derived from a biomass raw material have small heat shrinkages, as in the polyethylene 2,6-naphthalate film derived from a fossil raw material, and dimensional changes can be reduced when hard coating processing etc. are performed using these films. It also shows that these films easily return to a shape close to their original shape with little or no creases, especially when folded in a high-temperature environment.

### Example 2-1 and Comparative Example 3

Films were produced using PEN resins shown in Table 2, as follows. Mixed pellets were supplied to an extruder and melted at 300° C. The molten polymer was filtered through a sintered stainless-steel filter material (nominal filtration accuracy: 10 μm particle 95% cut) and extruded from a die into a sheet form. The sheet-form polymer was then brought into contact with a casting drum (surface temperature: 50° C.) by using an electrostatic casting method to solidify the polymer by cooling, thereby preparing an unstretched film. The unstretched film was uniformly heated to 120° C. using heating rolls, heated to a film temperature of 140° C. using an infrared heater disposed between low-speed and high-speed rolls, and stretched in the longitudinal direction at a speed ratio of the low-speed and high-speed rolls of 4.0 times to obtain a uniaxially stretched film. The film was then guided to a tenter, preheated at 130° C., and stretched 5.7-fold in the transverse direction at 145° C. With the width fixed, the film was subjected to heat fixation at 210° C. for 5 seconds and further relaxed by 1% in the width direction at 180° C., thereby obtaining a polyethylene 2,6-naphthalate film with a thickness of 5 μm. Table 2 shows the properties of the films.

### Examples 2-2 and 2-3

Polyethylene 2,6-naphthalate films were obtained in the same manner as in Example 2-1, except that the stretch ratio for stretching in the longitudinal direction, the stretch ratio for stretching in the transverse direction, and the thickness were as shown in Table 2. Table 2 shows the properties of these films.

### Comparative Example 4

A film was produced using the PET resins shown in Table 2, as follows. Mixed pellets were supplied to an extruder and melted at 285° C. The molten polymer was filtered through a sintered stainless-steel filter material (nominal filtration accuracy: 10 μm particle 95% cut) and extruded from a die into a sheet form. The sheet-form polymer was then brought into contact with a casting drum (surface temperature: 30° C.) by using an electrostatic casting method to solidify the polymer by cooling, thereby preparing an unstretched film. The unstretched film was uniformly heated to 75° C. using heating rolls, heated to a film temperature of 85° C. using an infrared heater disposed between low-speed and high-speed rolls, and stretched in the longitudinal direction at a speed ratio of the low-speed and high-speed rolls of 3.2 times to obtain a uniaxially stretched film. The film was then guided to a tenter, preheated at 100° C., and stretched 4.5-fold in the transverse direction at 110° C. With the width fixed, the film was subjected to heat fixation at 210° C. for 5 seconds and further relaxed by 1% in the width direction at 180° C., thereby obtaining a polyethylene terephthalate film with a thickness of 5 μm. Table 2 shows the properties of the film.

TABLE 2

| | | Ex. | Ex. | Ex. | Comp. | Comp. |
|---|---|---|---|---|---|---|
| | | 2-1 | 2-2 | 2-3 | Ex. 3 | Ex. 4 |
| Resin | PEN-1 | 50 | 50 | 50 | — | — |
| proportion | PEN-2 | — | — | — | 50 | — |
| | PEN-3 | 20 | 20 | 20 | 20 | — |
| | PEN-4 | 30 | 30 | 30 | 30 | — |
| | PEN-5 | — | — | — | — | — |
| | PET-1 | — | — | — | — | 39.7 |
| | PET-2 | — | — | — | — | 10.3 |
| | PET-3 | — | — | — | — | 20 |
| | PET-4 | — | — | — | — | 30 |
| Biomass-derived polymer content (%) | | 50 | 50 | 50 | 0 | 39.7 |
| Biomass degree (%) | | 12.4 | 12.4 | 12.4 | 0 | 12.4 |
| Thickness (μm) | | 5 | 3.5 | 5 | 5 | 5 |
| Stretch ratio | Longitudinal direction | 4 | 4 | 3.5 | 4 | 3.2 |
| | Transverse direction | 5.7 | 5.7 | 5.8 | 5.7 | 4.5 |
| Heat fixation temperature (° C.) | | 210 | 210 | 210 | 210 | 210 |
| Density (g/cm³) | | 1.35 | 1.35 | 1.34 | 1.35 | 1.383 |
| Heat shrinkage (%) | Longitudinal direction | 0.6 | 0.6 | 0.5 | 0.6 | 1.5 |
| 105° C., 30 min | Transverse direction | 0.3 | 0.3 | 0.3 | 0.3 | 1.5 |
| Elastic modulus (GPa) | Longitudinal direction | 6.1 | 6.1 | 6 | 6.1 | 4.5 |
| | Transverse direction | 10.5 | 10.5 | 11.5 | 10.5 | 7.2 |

| | | | | | |
|---|---|---|---|---|---|
| Coefficient of humidity expansion in | 6 | 6 | 5 | 6 | 7 |
| transverse direction (ppm/% RH) | | | | | |

As is clear from a comparison of Examples 2-1 to 2-3 with Comparative Examples 3 and 4, the polyester films containing polyethylene 2,6-naphthalate derived from a biomass raw material of the present invention have small heat shrinkages and high elastic moduli, as in the film containing only polyethylene 2,6-naphthalate derived from a fossil raw material, and are thus excellent in handling. In addition, the coefficient of humidity expansion in the width direction, which is particularly important when used as a magnetic tape substrate, can be small in these films, as in polyethylene 2,6-naphthalate derived from a fossil raw material.

### Example 3-1 and Comparative Example 5

Films were produced using PEN resins shown in Table 3, as follows. Mixed pellets were supplied to an extruder and melted at 315° C. The molten polymer was filtered through a sintered stainless-steel filter material (nominal filtration accuracy: 10 μm particle 95% cut) and extruded from a die into a sheet form. The sheet-form polymer was then brought into contact with a casting drum (surface temperature: 50° C.) by using an electrostatic casting method to solidify the polymer by cooling, thereby preparing an unstretched film. The unstretched film was uniformly heated to 120° C. using heating rolls, heated to a film temperature of 130° C. using an infrared heater disposed between low-speed and high-speed rolls, and stretched in the longitudinal direction at a speed ratio of the low-speed and high-speed rolls of 2.9 times to obtain a uniaxially stretched film. The film was then guided to a tenter, preheated at 120° C., and stretched 2.8-fold in the transverse direction at 140° C. With the width fixed, the film was subjected to heat fixation at 235° C. for 5 seconds and further relaxed by 3% in the width direction at 180° C., thereby obtaining a polyethylene 2,6-naphthalate film with a thickness of 250 μm. Table 3 shows the properties of the films.

### Examples 3-2 and 3-3

Polyethylene 2,6-naphthalate films were obtained in the same manner as in Example 3-1, except that the stretch ratio for stretching in the longitudinal direction, the stretch ratio for stretching in the transverse direction, the heat fixation temperature, and the thickness were as shown in Table 3. Table 3 shows the properties of these films.

### Comparative Example 6

A film was produced using PET resins shown in Table 3, as follows. Mixed pellets were supplied to an extruder and melted at 285° C. The molten polymer was filtered through a sintered stainless-steel filter material (nominal filtration accuracy: 10 μm particle 95% cut) and extruded from a die into a sheet form. The sheet-form polymer was then brought into contact with a casting drum (surface temperature: 30° C.) by using an electrostatic casting method to solidify the polymer by cooling, thereby preparing an unstretched film. The unstretched film was uniformly heated to 75° C. using heating rolls, heated to a film temperature of 85° C. using an infrared heater disposed between low-speed and high-speed rolls, and stretched in the longitudinal direction at a speed ratio of the low-speed and high-speed rolls of 2.9 times to obtain a uniaxially stretched film. The film was then guided to a tenter, preheated at 100° C., and stretched 2.8-fold in the transverse direction at 110° C. With the width fixed, the film was subjected to heat fixation at 230° C. for 5 seconds and further relaxed by 1% in the width direction at 180° C., thereby obtaining a polyethylene terephthalate film with a thickness of 250 μm. Table 3 shows the properties of the film.

### Example 4

The film having a thickness of 250 μm produced in Example 3-1 was pulverized, dried, supplied to an extruder, and melted at 310° C. The molten polymer was filtered through a sintered stainless-steel filter material (nominal filtration accuracy: 10 μm particle 95% cut), extruded from a die into a strand, water-cooled, and cut to a length of 5 mm to prepare recycled pellets. The recycled pellets are referred to as “PEN-5.” PEN-1, PEN-3, and PEN-5 were mixed in the proportions shown in Table 3, and the subsequent process was performed in the same manner as in Example 3-1 to obtain a polyethylene naphthalate film having a thickness of 250 μm. Table 3 shows the properties of the film.

TABLE 3

| | | Ex. | Ex. | Ex. | Comp. | Comp. | |
|---|---|---|---|---|---|---|---|
| | | 3-1 | 3-2 | 3-3 | Ex. 5 | Ex. 6 | Ex. 4 |
| Resin | PEN-1 | 80 | 80 | 80 | — | — | 40 |
| proportion | PEN-2 | — | — | — | 80 | — | — |
| | PEN-3 | 20 | 20 | 20 | 20 | — | 10 |
| | PEN-4 | — | — | — | — | — | — |
| | PEN-5 | — | — | — | — | — | 50 |
| | PET-1 | — | — | — | — | 63.4 | — |
| | PET-2 | — | — | — | — | 16.6 | — |
| | PET-3 | — | — | — | — | 20 | — |
| | PET-4 | — | — | — | — | — | — |
| Biomass-derived polymer content (%) | | 80 | 80 | 80 | 0 | 63.4 | 80 |
| Biomass degree (%) | | 19.8 | 19.8 | 19.8 | 0 | 19.8 | 19.8 |
| Thickness (μm) | | 250 | 188 | 100 | 250 | 250 | 250 |
| Stretch ratio | Longitudinal direction | 2.9 | 2.9 | 2.8 | 2.9 | 2.9 | 2.9 |
| | Transverse direction | 2.8 | 2.8 | 3 | 2.8 | 2.8 | 2.8 |
| Heat fixation temperature (° C.) | | 235 | 235 | 240 | 235 | 230 | 235 |
| Density (g/cm³) | | 1.358 | 1.358 | 1.359 | 1.358 | 1.398 | 1.358 |
| Heat shrinkage (%) | Longitudinal direction | 0.5 | 0.5 | 0.4 | 0.5 | — | 0.5 |
| 200° C., 10 min | Transverse direction | 0.4 | 0.4 | 0.4 | 0.4 | — | 0.4 |
| Heat shrinkage (%) | Longitudinal direction | 0.2 | 0.2 | 0.2 | 0.2 | 1 | 0.2 |
| 150° C., 30 min | Transverse direction | 0.2 | 0.2 | 0.2 | 0.2 | 0.6 | 0.2 |

| | | | | | | |
|---|---|---|---|---|---|---|
| Breakdown voltage (kV) | 28.4 | 28.4 | 29.5 | 28.4 | 23.1 | 28.4 |

As is clear from a comparison of Examples 3-1 to 3-3 with Comparative Examples 5 and 6, the polyester films containing polyethylene 2,6-naphthalate derived from a biomass raw material of the present invention have small heat shrinkages and high breakdown voltages, as in the film containing only polyethylene 2,6-naphthalate derived from a fossil raw material, and are thus also excellent as insulating materials.

The film of Example 4 maintains the same biomass degree and film properties as those of Examples 3-1 to 3-3, and in addition, since the film of Example 4 is produced using PEN-5, which is recycled pellets, the amounts of PEN-1 and PEN-3 used can be significantly reduced, thus greatly reducing the environmental burden.

### Example 5-1 and Comparative Example 7

Polyester films having a thickness of 40 μm were obtained in the same manner as in Example 1-1, except that the raw materials used, the stretch ratios, and the heat fixation temperature were as shown in Table 4. Table 4 shows the properties of the obtained films.

### Examples 5-2 to 5-4

Polyethylene 2,6-naphthalate films were obtained in the same manner as in Example 5-1, except that the stretch ratio for stretching in the longitudinal direction, the stretch ratio for stretching in the transverse direction, the heat fixation temperature, and the thickness were as shown in Table 4. Table 4 shows the properties of these films.

### Comparative Example 8

A polyester film having a thickness of 40 μm was obtained in the same manner as in Comparative Example 2, except that the raw materials used, the stretch ratios, and the heat fixation temperature were as shown in Table 4. Table 4 shows the properties of the obtained film.

TABLE 4

| | | Ex. | Ex. | Ex. | Ex. | Comp. | Comp. |
|---|---|---|---|---|---|---|---|
| | | 5-1 | 5-2 | 5-3 | 5-4 | Ex. 7 | Ex. 8 |
| Resin | PEN-1 | 100 | 100 | 100 | 100 | — | — |
| proportion | PEN-2 | — | — | — | — | 100 | — |
| | PEN-3 | — | — | — | — | — | — |
| | PEN-4 | — | — | — | — | — | — |
| | PEN-5 | — | — | — | — | — | — |
| | PET-1 | — | — | — | — | — | 79.4 |
| | PET-2 | — | — | — | — | — | 20.6 |
| | PET-3 | — | — | — | — | — | — |
| | PET-4 | — | — | — | — | — | — |
| Biomass-derived polymer content (%) | | 100 | 100 | 100 | 100 | 0 | 79.4 |
| Biomass degree (%) | | 24.8 | 24.8 | 24.8 | 24.8 | 0 | 24.8 |
| Thickness (μm) | | 40 | 40 | 40 | 60 | 40 | 40 |
| Stretch ratio | Longitudinal direction | 1.0 | 1.0 | 1.0 | 1.0 | 1.0 | 1.0 |
| | Transverse direction | 4.5 | 5 | 4 | 4 | 4.5 | 4.0 |
| Heat fixation temperature (° C.) | | 200 | 200 | 210 | 200 | 200 | 180 |
| Density (g/cm³) | | 1.350 | 1.350 | 1.350 | 1.350 | 1.350 | 1.380 |
| Heat shrinkage | Longitudinal direction | 0.6 | 0.6 | 0.6 | 0.6 | 0.3 | 1.3 |
| 150° C., 30 min | Transverse direction | 0 | 0 | 0 | 0 | 0 | 0.8 |

| | | | | | | |
|---|---|---|---|---|---|---|
| Retardation | 8100 | 8600 | 7500 | 11250 | 8100 | 3900 |
| Observation of rainbow unevenness | ∘ | ∘ | ∘ | ∘ | ∘ | x |

As is clear from a comparison of Examples 5-1 to 5-4 with Comparative Examples 7 and 8, the polyester films containing polyethylene 2,6-naphthalate derived from a biomass raw material of the present invention can have high retardations, as in the film containing only polyethylene 2,6-naphthalate derived from a fossil raw material, and can be incorporated into display devices as thin polarizing element protective films without causing rainbow unevenness.

### Example 6-1 and Comparative Example 9

Polyester films having a thickness of 25 μm were produced in the same manner as in Example 3-1, except that the raw materials used, the stretch ratios, the heat fixation temperature, and the thickness were as shown in Table 5, and aqueous coating liquid B having a solids concentration of 3 wt % was applied in an amount of 4 g/m² to one surface of the uniaxially stretched film by kiss coating. Table 5 shows the properties of the obtained films. Coating liquid B was prepared by mixing 90 wt % on a solids basis of an acrylic copolymer composed of 70 mol % methyl methacrylate, 22 mol % ethyl acrylate, 4 mol % N-methylolacrylamide, and 4 mol % N, N-dimethylacrylamide, with 10 wt % of polyoxyethylene lauryl ether (n=7).

### Examples 6-2 and 6-3

Polyethylene 2,6-naphthalate films were obtained in the same manner as in Example 6-1, except that the stretch ratio for stretching in the longitudinal direction, the stretch ratio for stretching in the transverse direction, and the thickness were as shown in Table 5. Table 5 shows the properties of these films.

### Comparative Example 9

A polyester film having a thickness of 25 μm was obtained in the same manner as in Comparative Example 6, except that the raw materials used, the stretch ratios, the heat fixation temperature, and the thickness were as shown in Table 5, and aqueous coating liquid B having a solids concentration of 3 wt % was applied in an amount of 4 g/m² to one surface of the uniaxially stretched film by kiss coating in the same manner as in Example 6-1.

TABLE 5

| | | Ex. | Ex. | Ex. | Comp. | Comp. |
|---|---|---|---|---|---|---|
| | | 6-1 | 6-2 | 6-3 | Ex. 9 | Ex. 10 |
| Resin | PEN-1 | 80 | 80 | 80 | — | — |
| proportion | PEN-2 | — | — | — | 80 | — |
| | PEN-3 | — | — | — | — | — |
| | PEN-4 | — | — | — | — | — |
| | PEN-5 | — | — | — | — | — |
| | PEN-6 | 20 | 20 | 20 | 20 | — |
| | PET-1 | — | — | — | — | 63.4 |
| | PET-2 | — | — | — | — | 16.6 |
| | PET-3 | — | — | — | — | — |
| | PET-4 | — | — | — | — | — |
| | PET-5 | — | — | — | — | 20 |
| Biomass-derived polymer content (%) | | 80 | 80 | 80 | 0 | 63.4 |
| Biomass degree (%) | | 19.8 | 19.8 | 19.8 | 0 | 19.8 |
| Thickness (μm) | | 25 | 188 | 25 | 25 | 25 |
| Stretch ratio | Longitudinal direction | 3.1 | 3.1 | 3.3 | 3.1 | 3.1 |
| | Transverse direction | 3.5 | 3.5 | 3.7 | 3.5 | 3.5 |
| Heat fixation temperature (° C.) | | 245 | 245 | 245 | 245 | 230 |
| Density (g/cm³) | | 1.360 | 1.360 | 1.363 | 1.360 | 1.399 |
| Heat shrinkage (%) | Longitudinal direction | 1.2 | 1.2 | 1.3 | 1.2 | — |
| 230° C., 10 min | Transverse direction | 0.5 | 0.5 | 0.6 | 0.5 | — |
| Heat shrinkage (%) | Longitudinal direction | 0.3 | 0.3 | 0.3 | 0.3 | 1.2 |
| 150° C., 30 min | Transverse direction | 0.1 | 0.1 | 0.1 | 0.1 | 0.8 |
| Hot-water resistance | hr | 200 | 200 | 220 | 200 | 70 |
| Oxygen permeability | cc/m² · 24 hr · atm | 9 | 9 | 8 | 9 | 30 |
| coefficient | | | | | | |

| | | | | | |
|---|---|---|---|---|---|
| Reinforcing member performance evaluation | ∘ | ∘ | ∘ | ∘ | x |

As is clear from a comparison of Examples 6-1 to 6-3 with Comparative Examples 9 and 10, the polyester films containing polyethylene 2,6-naphthalate derived from a biomass raw material of the present invention have excellent hot-water resistance and excellent oxygen impermeability, as in the film containing only polyethylene 2,6-naphthalate derived from a fossil raw material. Furthermore, when used as reinforcing members, they have excellent vibration durability at high temperatures, and when used as reinforcing members for the polymer electrolyte membrane of a solid polymer electrolyte fuel cell, they can maintain mechanical strength over a long period of time even in high-temperature and high-humidity environments, and can maintain airtightness (gas sealing properties) without placing a load on the electrolyte membrane.

### Example 7-1 and Comparative Example 11

Polyester films having a thickness of 125 μm were obtained in the same manner as in Example 3-1, except that the raw materials used, the stretch ratios, the heat fixation temperature, and the thickness were as shown in Table 6. Table 6 shows the properties of the obtained films.

### Examples 7-2 and 7-3

Polyethylene 2,6-naphthalate films were obtained in the same manner as in Example 7-1, except that the stretch ratio for stretching in the longitudinal direction, the stretch ratio for stretching in the transverse direction, the heat fixation temperature, and the thickness were as shown in Table 6. Table 6 shows the properties of these films.

### Comparative Example 12

A polyester film having a thickness of 125 μm was obtained in the same manner as in Comparative Example 6, except that the raw materials used, the stretch ratios, the heat fixation temperature, and the thickness were as shown in Table 6. Table 6 shows the properties of the obtained film.

TABLE 6

| | | Ex. | Ex. | Ex. | Comp. | Comp. |
|---|---|---|---|---|---|---|
| | | 7-1 | 7-2 | 7-3 | Ex. 11 | Ex. 12 |
| Resin | PEN-1 | 80 | 80 | 80 | — | — |
| proportion | PEN-2 | — | — | — | 80 | — |
| | PEN-3 | — | — | — | — | — |
| | PEN-4 | — | — | — | — | — |
| | PEN-5 | — | — | — | — | — |
| | PEN-6 | 20 | 20 | 20 | 20 | — |
| | PET-1 | — | — | — | — | 63.4 |
| | PET-2 | — | — | — | — | 16.6 |
| | PET-3 | — | — | — | — | — |
| | PET-4 | — | — | — | — | — |
| | PET-5 | — | — | — | — | 20 |
| Biomass-derived polymer content (%) | | 80 | 80 | 80 | 0 | 63.4 |
| Biomass degree (%) | | 19.8 | 19.8 | 19.8 | 0 | 19.8 |
| Thickness (μm) | | 125 | 50 | 125 | 125 | 125 |
| Stretch ratio | Longitudinal direction | 3.1 | 3.1 | 3.3 | 3.1 | 3.1 |
| | Transverse direction | 3.5 | 3.5 | 3.6 | 3.5 | 3.5 |
| Heat fixation temperature (° C.) | | 240 | 240 | 245 | 240 | 230 |
| Density (g/cm³) | | 1.359 | 1.359 | 1.370 | 1.359 | 1.399 |
| Heat shrinkage (%) | Longitudinal direction | 0.3 | 0.3 | 0.3 | 0.3 | 1.2 |
| 150° C., 30 min | Transverse direction | 0.3 | 0.3 | 0.3 | 0.3 | 0.8 |
| Heat curl height | mm | 0.6 | 0.3 | 0.5 | 0.6 | 10 |

| | | | | | |
|---|---|---|---|---|---|
| Membrane switch deformation | ∘ | ∘ | ∘ | ∘ | x |

As is clear from a comparison of Examples 7-1 to 7-3 with Comparative Examples 11 and 12, the polyester films containing polyethylene 2,6-naphthalate derived from a biomass raw material of the present invention are less likely to curl when heated, as in the film containing only polyethylene 2,6-naphthalate derived from a fossil raw material. In addition, they have excellent durability at high temperatures when used as membrane touch switches, and are particularly useful as membrane touch switches for use in automobiles.

### Example 8-1 and Comparative Example 13

Rolls of polyester films having a thickness of 50 μm were obtained in the same manner as in Example 3-1, except that the raw materials used, the stretch ratios, the heat fixation temperature, and the thickness were as shown in Table 7. Table 7 shows the properties of the obtained films.

### Examples 8-2 and 8-3

Polyethylene 2,6-naphthalate films were obtained in the same manner as in Example 8-1, except that the thickness was as shown in Table 7. Table 7 shows the properties of these films.

### Comparative Example 14

A roll of a polyester film having a thickness of 50 μm was obtained in the same manner as in Comparative Example 6, except that the raw materials used, the stretch ratios, the heat fixation temperature, and the thickness were as shown in Table 7. Table 7 shows the properties of the obtained film.

TABLE 7

| | | Ex. | Ex. | Ex. | Comp. | Comp. |
|---|---|---|---|---|---|---|
| | | 8-1 | 8-2 | 8-3 | Ex. 13 | Ex. 14 |
| Resin | PEN-1 | 80 | 80 | 80 | — | — |
| proportion | PEN-2 | — | — | — | 80 | — |
| | PEN-3 | 20 | 20 | 20 | 20 | — |
| | PEN-4 | — | — | — | — | — |
| | PEN-5 | — | — | — | — | — |
| | PET-1 | — | — | — | — | 63.4 |
| | PET-2 | — | — | — | — | 16.6 |
| | PET-3 | — | — | — | — | 20 |
| | PET-4 | — | — | — | — | — |
| Biomass-derived polymer content (%) | | 80 | 80 | 80 | 0 | 63.4 |
| Biomass degree (%) | | 19.8 | 19.8 | 19.8 | 0 | 19.8 |
| Thickness (μm) | | 50 | 125 | 25 | 50 | 50 |
| Stretch ratio | Longitudinal direction | 3.0 | 3.0 | 3.0 | 3.0 | 3.0 |
| | Transverse direction | 3.6 | 3.6 | 3.6 | 3.6 | 3.6 |
| Heat fixation temperature (° C.) | | 246 | 246 | 246 | 246 | 230 |
| Density (g/cm³) | | 1.360 | 1.360 | 1.360 | 1.360 | 1.398 |
| Heat shrinkage (%) | Longitudinal direction | 1.2 | 1.2 | 1.2 | 1.2 | — |
| 230° C., 10 min | Transverse direction | 0.4 | 0.4 | 0.4 | 0.4 | — |
| Heat shrinkage (%) | Longitudinal direction | 0.20 | 0.20 | 0.20 | 0.20 | 1.0 |
| 150° C., 30 min | Transverse direction | 0.15 | 0.15 | 0.15 | 0.15 | 0.6 |

| | | | | | |
|---|---|---|---|---|---|
| Glass transition temperature (° C.) | 120 | 120 | 120 | 120 | 78 |
| Evaluation of anticorrosive properties | ∘ | ∘ | ∘ | ∘ | x |
| (decorative paint replacement film) | | | | | |
| Heat cycle test (flexible circuit board) | ∘ | ∘ | ∘ | ∘ | x |

As is clear from a comparison of Examples 8-1 to 8-3 with Comparative Examples 13 and 14, the polyester films containing polyethylene 2,6-naphthalate derived from a biomass raw material of the present invention are particularly useful as decorative paint replacement films, as in the film containing only polyethylene 2,6-naphthalate derived from a fossil raw material.

Examples 9-1 to 9-3 and Comparative Example 15 The films obtained in Examples 8-1 to 8-3 and Comparative Example 13 were further subjected to heat treatment at 230° C. for 5 minutes using a suspension-type relaxation heat treatment apparatus. Table 8 shows the properties of the obtained films.

TABLE 8

| | | | | | Comp. |
|---|---|---|---|---|---|
| | | Ex. 9-1 | Ex. 9-2 | Ex. 9-3 | Ex. 15 |
| Resin proportion | PEN-1 | 80 | 80 | 80 | — |
| | PEN-2 | — | — | — | 80 |
| | PEN-3 | 20 | 20 | 20 | 20 |
| | PEN-4 | — | — | — | — |
| | PEN-5 | — | — | — | — |
| | PET-1 | — | — | — | — |
| | PET-2 | — | — | — | — |
| | PET-3 | — | — | — | — |
| | PET-4 | — | — | — | — |
| Biomass-derived polymer content (%) | | 80 | 80 | 80 | 0 |
| Biomass degree (%) | | 19.8 | 19.8 | 19.8 | 0 |
| Thickness (μm) | | 50 | 125 | 25 | 50 |
| Stretch ratio | Longitudinal | 3.0 | 3.0 | 3.0 | 3.0 |
| | direction | | | | |
| | Transverse direction | 3.6 | 3.6 | 3.6 | 3.6 |
| Heat fixation temperature (° C.) | | 246 | 246 | 246 | 246 |
| Annealing treatment 230° C., 5 min | | Performed | Performed | Performed | Performed |
| Density (g/cm³) | | 1.361 | 1.361 | 1.361 | 1.361 |
| Heat shrinkage (%) | Longitudinal | 1.1 | 1.1 | 1.1 | 1.1 |
| 230° C., 10 min | direction | | | | |
| | Transverse direction | 0.3 | 0.3 | 0.3 | 0.3 |
| Heat shrinkage (%) | Longitudinal | 0.15 | 0.15 | 0.15 | 0.15 |
| 150° C., 30 min | direction | | | | |
| | Transverse direction | 0.1 | 0.1 | 0.1 | 0.1 |

| | | | | |
|---|---|---|---|---|
| Heat cycle test (flexible circuit board) | ∘ | ∘ | ∘ | ∘ |

As is clear from Table 8, the polyester films containing polyethylene 2,6-naphthalate derived from a biomass raw material of the present invention have extremely small heat shrinkages, as in the film containing only polyethylene 2,6-naphthalate derived from a fossil raw material, and can be thus suitably used as films for flexible circuit boards having excellent via connection reliability.

### Example 10-1 and Comparative Example 16

Polyethylene 2,6-naphthalate films having a thickness of 1.5 μm were obtained in the same manner as in Example 3-1, except that the raw materials used, the stretch ratios, the heat fixation temperature, and the thickness were as shown in Table 9. Table 9 shows the properties of the obtained films.

### Examples 10-2 and 10-3

Polyethylene 2,6-naphthalate films were obtained in the same manner as in Example 10-1, except that the heat fixation temperature and the thickness were as shown in Table 9. Table 9 shows the properties of these films.

TABLE 9

| | | | | | Comp. |
|---|---|---|---|---|---|
| | | Ex. 10-1 | Ex. 10-2 | Ex. 10-3 | Ex. 16 |
| Resin proportion | PEN-1 | 80 | 80 | 80 | — |
| | PEN-2 | — | — | — | 80 |
| | PEN-3 | — | — | — | — |
| | PEN-4 | — | — | — | — |
| | PEN-5 | — | — | — | — |
| | PEN-6 | 20 | 20 | 20 | 20 |
| | PET-1 | — | — | — | — |
| | PET-2 | — | — | — | — |
| | PET-3 | — | — | — | — |
| | PET-4 | — | — | — | — |
| | PET-5 | — | — | — | — |
| Biomass-derived polymer content (%) | | 80 | 80 | 80 | 0 |
| Biomass degree (%) | | 19.8 | 19.8 | 19.8 | 0 |
| Thickness (μm) | | 1.5 | 4.5 | 1.5 | 1.5 |
| Stretch ratio | Longitudinal direction | 3.6 | 3.6 | 3.6 | 3.6 |
| | Transverse direction | 3.9 | 3.9 | 3.9 | 3.9 |

| | | | | |
|---|---|---|---|---|
| Heat fixation temperature (° C.) | 210 | 210 | 230 | 210 |
| Density (g/cm³) | 1.358 | 1.358 | 1.361 | 1.358 |
| Breakdown voltage (V/μm) | 390 | 390 | 400 | 390 |
| Dielectric loss tangent (tanδ) at 100° C. | 0.003 | 0.003 | 0.002 | 0.003 |

As is clear from a comparison of Examples 10-1 to 10-3 with Comparative Example 16, the polyester films containing polyethylene 2,6-naphthalate derived from a biomass raw material of the present invention have high breakdown voltages and low tanδ values at a high temperature of 100° C., as in the film containing only polyethylene 2,6-naphthalate derived from a fossil raw material. When used as film capacitors, they have durability and low dielectric loss tangents (tanδ) and are particularly useful as film capacitors for high-temperature, high-capacity applications.

### Example 11-1 and Comparative Example 17

Polyethylene 2,6-naphthalate films having a thickness of 50 μm were obtained in the same manner as in Example 1-1, except that the raw material used, the stretch ratios, the heat fixation temperature, and the thickness were as shown in Table 10. Table 10 shows the properties of the obtained films.

### Examples 11-2 and 11-3

Polyethylene 2,6-naphthalate films were obtained in the same manner as in Example 11-1, except that the stretch ratio for stretching in the longitudinal direction, the stretch ratio for stretching in the transverse direction, the heat fixation temperature, and the thickness were as shown in Table 10. Table shows the properties of these films.

TABLE 10

| | | | | | Comp. |
|---|---|---|---|---|---|
| | | Ex. 11-1 | Ex. 11-2 | Ex. 11-3 | Ex. 17 |
| Resin proportion | PEN-1 | 100 | 100 | 100 | |
| | PEN-2 | — | — | — | 100 |
| | PEN-3 | — | — | — | — |
| | PEN-4 | — | — | — | — |
| | PEN-5 | — | — | — | — |
| | PET-1 | — | — | — | — |
| | PET-2 | — | — | — | — |
| | PET-3 | — | — | — | — |
| | PET-4 | — | — | — | — |
| Biomass-derived polymer content (%) | | 100 | 100 | 100 | 100 |
| Biomass degree (%) | | 24.8 | 24.8 | 24.8 | 24.8 |
| Thickness (μm) | | 50 | 125 | 50 | 50 |
| Stretch ratio | Longitudinal | 3.3 | 3.3 | 3.5 | 3.3 |
| | direction | | | | |
| | Transverse | 3.4 | 3.7 | 3.9 | 3.4 |
| | direction | | | | |
| Heat fixation temperature (° C.) | | 200 | 200 | 220 | 200 |
| Density (g/cm³) | | 1.36 | 1.36 | 1.36 | 1.36 |
| Heat shrinkage | Longitudinal | 0.4 | 0.3 | 0.4 | 0.4 |
| 150° C., 30 min | direction | | | | |
| | Transverse | 0 | 0 | 0.1 | 0 |
| | direction | | | | |
| Total light transmittance (%) | | 90 | 90 | 90 | 90 |
| Oxygen permeability | cc/m² · 24 | 9 | 9 | 8 | 9 |
| coefficient | hr · atm | | | | |

| | | | | |
|---|---|---|---|---|
| UV transmission at 360 nm | 0 | 0 | 0 | 0 |

As is clear from a comparison of Examples 11-1 to 11-3 with Comparative Example 17, the polyester films containing polyethylene 2,6-naphthalate derived from a biomass raw material of the present invention have low heat shrinkages, excellent dimensional stability, low oxygen permeability coefficients, and low UV transmittances at 360 nm, as in the film containing only polyethylene 2,6-naphthalate derived from a fossil raw material, and are particularly useful as films requiring barrier properties, especially for applications requiring high-barrier properties, such as barrier films for organic EL and quantum dot substrate films.

### INDUSTRIAL APPLICABILITY

The polyester film containing polyethylene naphthalate (e.g., polyethylene 2,6-naphthalate) derived from a biomass raw material of the present invention is extremely excellent in thermal, mechanical, and electrical properties, as in a film containing only polyethylene naphthalate (e.g., polyethylene 2,6-naphthalate) derived from a fossil raw material, and can be usefully used in a wide range of applications, such as display devices, automotive applications, and information and communications.

### DESCRIPTION OF THE REFERENCE NUMERALS

1: sample film
11: PTFE plate
12: spacer
13: hold angle
21: diameter of the outermost surface
22: diameter of the neutral plane
23: diameter of the innermost surface

1. A polyester film comprising a polyester that comprises a diol unit containing an ethylene glycol unit derived from a biomass raw material and a dicarboxylic acid unit containing a naphthalenedicarboxylic acid unit.

2. The polyester film according to claim 1, wherein the proportion of the polyester is 1 to 100 mass % based on the total resin amount contained in the polyester film.

3. The polyester film according to claim 1, which is stretched in at least one direction.

4. The polyester film according to claim 1, for use in any of the following (1) to (13):
(1) an electrical insulation film,
(2) a flexible circuit board,
(3) a flexible circuit board cover film,
(4) a film capacitor,
(5) a polarizing element protective film,
(6) a surface protection film for displays,
(7) a high-barrier substrate,
(8) a film for foldable displays,
(9) an insulation film for motors,
(10) a membrane touch switch substrate,
(11) a gasket for fuel cells,
(12) a magnetic tape substrate, and
(13) a decorative film.

5. The polyester film according to claim 2, which is stretched in at least one direction.

6. The polyester film according to claim 2, for use in any of the following (1) to (13):
(1) an electrical insulation film,
(2) a flexible circuit board,
(3) a flexible circuit board cover film,
(4) a film capacitor,
(5) a polarizing element protective film,
(6) a surface protection film for displays,
(7) a high-barrier substrate,
(8) a film for foldable displays,
(9) an insulation film for motors,
(10) a membrane touch switch substrate,
(11) a gasket for fuel cells,
(12) a magnetic tape substrate, and
(13) a decorative film.
